(19) United States
(12) Patent Application Publication
(10) Pub. No.: US 2025/0041736 A1
(43) Pub. Date: Feb. 6, 2025

(54) PROCESSING DEVICES AND METHODS FOR GENERATING A GROUP OF USERS

(71) Applicant: Sony Interactive Entertainment Inc., Tokyo (JP)

(72) Inventors: Nicholas Anthony Edward Ryan, London (GB); Andrew William Walker, London (GB); Mark Anderson, London (GB); Michael Eder, London (GB); Jesus Lucas Barcias, London (GB)

(73) Assignee: Sony Interactive Entertainment Inc., Tokyo (JP)

(21) Appl. No.: 18/784,987

(22) Filed: Jul. 26, 2024

(30) Foreign Application Priority Data
Aug. 3, 2023 (GB) 2311934.0

(51) Int. Cl. A63F 13/795

(52) U.S. Cl. CPC A63F 13/795

(57) ABSTRACT

A processing device for generating a group of users for a first user to complete a given task in a video game, completion requiring one or more in-game characteristics, the processing device comprising: an identification unit configured to identify one or more requirements of the given task; a selection unit configured to select one or more other users from a plurality of other users, wherein a respective one of the other users is selected in dependence upon at least one of the requirements and one or more in-game characteristics associated with the respective other user; and a group generation unit configured to generate the group for the first user to complete the given task, the generated group comprising the first user and the one or more selected other users.

### BACKGROUND OF THE INVENTION

### Field of Invention

The present invention relates to processing devices and methods for generating a group of users.

### Description of the Prior Art

Over time, video games have become an increasingly popular hobby. One type of video game is a multiplayer video game, where multiple users may cooperatively play with, or competitively play against, one another. Multiple users may join a multiplayer video game session by using the same device (e.g. split screen multiplayer), or by connecting, via a network, to one another via a peer-to-peer (P2P) network or to a server that acts as a host for the multiplayer gaming session.

In some types of games, including but not limited to some types of multiplayer games, a user may be able to specialise into one or more roles (such as healer, tank or damage dealer) or select one or more classes (such as engineer, sniper or medic). Once a given user has specialised into a specific role or selected a particular class, the user may benefit from to join or form a group with one or more other users that complement the given user. It should be noted that users might benefit from joining or forming a group even for games that do not include roles and/or classes.

A user that is a member of a group may be more successful in comparison to playing on their own. However, not all groups are created equally. Some group compositions may perform better than other group compositions. Therefore, users will often spend a significant amount of time creating groups and trialling different group compositions to discover a group composition and to discover the other users for that group composition.

It is in this context that the present disclosure arises.

### SUMMARY OF THE INVENTION

In a first aspect, a processing device is provided in claim 1.

In another aspect, a method for generating a group of users is provided in claim 13.

Further respective aspects and features of the invention are defined in the appended claims.

### BRIEF DESCRIPTION OF THE DRAWINGS

Embodiments of the present invention will now be described by way of example with reference to the accompanying drawings, in which:

FIG. 1 schematically illustrates an example entertainment system;

FIG. 2 schematically illustrates an example processing device; and

FIG. 3 schematically illustrates an example method.

### DESCRIPTION OF THE EMBODIMENTS

In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

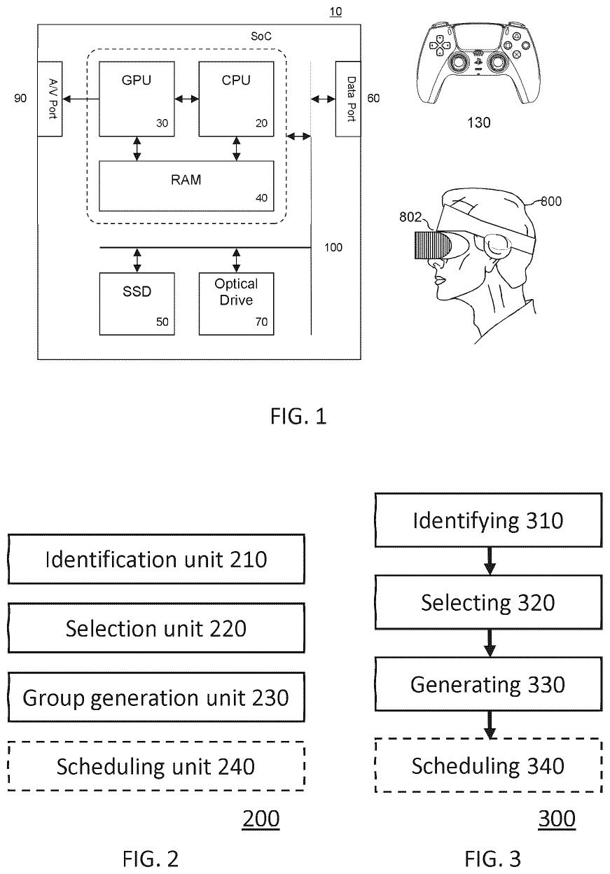

Referring to FIG. 1, an example of an entertainment system 10 is a computer or console such as the Sony® PlayStation 5® (PS5).

The entertainment system 10 comprises a central processor 20. This may be a single or multi core processor, for example comprising eight cores as in the PS5. The entertainment system also comprises a graphical processing unit or GPU 30. The GPU can be physically separate to the CPU, or integrated with the CPU as a system on a chip (SoC) as in the PS5.

The entertainment device also comprises RAM 40, and may either have separate RAM for each of the CPU and GPU, or shared RAM as in the PS5. The or each RAM can be physically separate, or integrated as part of an SoC as in the PS5. Further storage is provided by a disk 50, either as an external or internal hard drive, or as an external solid state drive, or an internal solid state drive as in the PS5.

The entertainment device may transmit or receive data via one or more data ports 60, such as a USB port, Ethernet® port, Wi-Fi® port, Bluetooth® port or similar, as appropriate. It may also optionally receive data via an optical drive 70.

Interaction with the system is typically provided using one or more handheld controllers 130, such as the DualSense® controller in the case of the PS5.

Audio/visual outputs from the entertainment device are typically provided through one or more A/V ports 90, or through one or more of the wired or wireless data ports 60.

Where components are not integrated, they may be connected as appropriate either by a dedicated data link or via a bus 100.

An example of a device for displaying images output by the entertainment system is a head mounted display ‘HMD’ 802, worn by a user 800. Alternatively, or in addition, a TV or monitor may be used.

Users will often spend a significant amount of time creating groups and trialling different group compositions to discover a group composition for a video game and to discover the other users for that group composition. Additionally, a group or group composition that is suitable for one task or type of task may be unsuitable for another task or type of task. Therefore, a user may have to spend a significant amount of time creating groups and trialling different group compositions for every task that they are trying to complete with a group. Therefore, it is desirable to provide techniques for generating a group of users for a first user to complete a given task in a video game

Accordingly, turning now to FIG. 2, in an embodiment of the present description, a processing device 200 for generating a group of users for a first user to complete a given task in a video game, completion requiring one or more in-game characteristics, is provided. The processing device 200 comprises an identification unit 210; a selection unit 220; and a group generation unit 230. The identification unit 210, selection unit 220 and group generation unit 230 will each be discussed in turn.

The given task is a task that the user may complete in a video game or a virtual environment. For example, a task may be an in-game quest or objective; a so called “raid” event, dungeon or instance; achieving a particular trophy or achievement; acquiring a specific in-game item; reaching an in-game milestone such as achieving a certain character level or acquiring a threshold amount of an in-game item or currency; reaching a location or region in a virtual environment; or any other suitable task. Hence a task may be explicitly set (e.g. a quest) or simply acknowledged when achieved (e.g. a trophy).

The in-game characteristics may be the characteristics of a respective user of the video game and/or their associated in-game avatar. Example in-game characteristics include a user's skill level; the level of a user's in-game avatar/character; the number of trophies/achievements a user has/has not obtained; whether a user has/has not obtained a particular trophy/achievement; a user's in-game specialisation/build/role (e.g. healer, damage dealer (DPS), tank, etc.); the content of a user's in-game inventory; whether a user has acquired a particular in-game item; whether a user has visited or has access to a particular in-game area/location/region; a user's total play time; a user's average session length; when a user is likely to be available/unavailable; the items equipped by a user's in-game avatar/character; whether a user uses a microphone to communicate; the languages known by a user; a level of progression in the video-game by a user (e.g. how far the user has progressed in the in-game storyline or how many tasks the user has already completed); a user's real word region (which may be indicative of the languages spoken by a user, what times a user is likely to be available, and/or an amount of latency that a user will experience with other users); or any other suitable characteristics.

The identification unit 210 of the present disclosure is configured to identify one or more requirements of the given task.

The requirements that are identified by the identification unit 210 may specify one or more in-game characteristics that are needed to complete the given task. However, in some cases, one or more of the requirements may merely specify one or more in-game characteristics that are preferable for other users to have for assisting the user in completing the given task.

For example, in some embodiments of the present disclosure, the one or more requirements may comprise one or more user specific requirements that correspond to the one or more in-game characteristics of a respective user.

Example user specific requirements include a minimum or maximum in-game level of the user's in-game avatar/character; the user's in-game avatar being one of one or more specific types of build/role/specialisation; a minimum/maximum skill level of the user (which may be quantified using an Elo based system such as the Glicko rating system for example); whether the user has reached a threshold level of progression in the video game; or any other suitable requirements that correspond to the one or more in-game characteristics of a respective user.

Optionally, in these embodiments, the identification unit 210 may be configured to identify the one or more user specific requirements for the given task in dependence upon one or more in-game characteristics of respective users in one or more other groups that have completed the given task.

For example, respective users in one or more other groups that have already completed a given task may have all had an in-game level of at least a particular value. Therefore, in dependence upon this information, the identification unit 210 may identify that a respective user's in-game avatar should have an in-game level of at least that particular value as a user specific requirement for that given task.

Alternatively, or in addition, in some embodiments of the present disclosure, the one or more requirements may comprise one or more group requirements that correspond to the combined complement of in-game characteristics associated with members of a group for the given task.

Example group requirements include a minimum and/or maximum number of users that form a group; a minimum/maximum threshold for the sum of the levels of the in-game avatars of all users in a group; a total number of builds/roles/specialisations that need to be filled by the members in a group (e.g. a group of 8 users for a given task will require at least 3 healers, 1 tank, 3 DPS's and 1 user that may have any role/build/specialisation); or any other suitable requirements that correspond to the combined complement of in-game characteristics associated with members of a group.

Optionally, in these embodiments, the identification unit 210 may be configured to identify the one or more group requirements in dependence upon the combined complement of in-game characteristics associated with members of one or more other groups that have completed the given task.

For example, one or more other groups that have already completed a given task may have all had at least a particular number of members in total and/or a certain number of members having a particular build/role/specialisation. Therefore, in dependence upon this information, the identification unit 210 may identify that a group must have at least the particular number of members in total and/or the certain number of members having the particular build/role/specialisation as a group specific requirement for that given task.

Hence optionally the identification unit may identify the requirements of a given task based on characteristics that are consistently present when the task is achieved a plurality of times by respective different users or groups of users. This may be done initially by a server that receives information about task completion from multiple users to aggregate and detect this information, and then an identification unit on a user device may request and receive this information. Alternatively or in addition, optionally the game itself may provide this information as metadata associated with tasks.

The selection unit 220 is configured to select one or more other users from a plurality of other users, wherein a respective one of the other users is selected in dependence upon at least one of the requirements and one or more in-game characteristics associated with the respective other user.

In some cases, the plurality of other users comprises users that are also looking to form or join a group for the given task. However, it should be noted that the techniques described herein are not limited to such a formulation. For example, the plurality of users may, alternatively or additionally, comprise users that have provided an indication that they would be willing to join a group for undertaking tasks. The indication may indicate that those users are willing to join a group for any type of task, or may indicate that those users are willing to join a group for tasks of one or more types.

In some cases, the selection unit 220 may be configured to select all of the plurality of other users whose respective in-game characteristics meet the at least one of the requirements. In this case, the selection unit 220 may be configured to transmit an invitation to join the group to the selected other users. However, there may be a limit on a total size for a group, or a limit on the amount of other users for the group that meet the at least one of the requirements (and another limit on an amount of other users that meet at least another one of the requirements, etc.). The selected other users may then be added to the group by accepting the invitation on a first come, first served basis.

Alternatively, the selection unit 220 may be configured to select one or some of the plurality of other users whose respective in-game characteristics meet the at least one of the requirements. In this case, the selection unit 220 may be configured to select one of the other users over another of the other users (even when both of the other users meet the at least one of the requirements) in response to one or more of the in-game characteristics associated with the one of the other users being better (e.g. a higher in-game level, more likely to be available at a particular time, has progressed further in the video game) than the in-game characteristics associated with the other one of the other users.

It will be appreciated that the selection unit may be located at a server administrating a multiplayer aspect of the game, or on a console of the first user, or a combination of the two—for example the console may identify friends of the first user, and request that the server identifies those with complementary in-game characteristics. This may thus comprise both identification and selection steps at the server. Alternatively the server can return all candidates and the first user's console can make the selection based on one or more criteria (e.g. relative ping times, user choice, time of day, etc).

In some embodiments of the present disclosure, a respective one of the other users may be selected in response to at least one of their associated in-game characteristics complementing users already in or selected for the group of users. Typically, and as described elsewhere herein, the complementary characteristics are from within the set of characteristics required to complete the given task or goal of the group. In other words, preferably a respective one of the other users may be selected in response to at least one of their associated in-game characteristics complementing in-game characteristics of users already in or selected for the group of users within an overall set of characteristics required to achieve a given task or goal.

As an illustrative example, consider the following users A, B, C, D and E. User A may be the first user, and is ipso facto a member of the group for the given task. In this case, users B, C, D and E may be the plurality of other users. The table below illustrates an example of at least some of the possible characteristics that may be possessed by users A, B, C, D and E.

| Characteristic | User A | User B | User C | User D | User E |
|---|---|---|---|---|---|
| Skill level | 1500 | 1200 | 2000 | 1500 | 2100 |
| Build | Healer | Tank | DPS | Tank | DPS |
| Availability | 14:00-20:00 | 16:00-22:00 | 10:00-20:00 | 16:00-22:00 | 08:00-12:00 |
| Languages | DE, FR, GB | FR | DE, FR | GB | DE, FR, GB |

In this illustrative example, the identification unit 210 may have identified that one of the requirements for the group may be that the group has a maximum of 3 members (including the first user) and that one of the members should be a healer, one should be a tank and one should be a DPS. From these requirements and the characteristics of the first user (user A), it is determined that the selection unit 220 should select a user that is a tank (i.e. one of user B or user D) and another user that is a DPS (i.e. one of user C or user E) because the first user (i.e. user A) already meets the healer requirement for the group.

The selection unit 220 may, for example, select the user that is a DPS first because both the users that are DPSs are a higher skill level than the other users. In this example, the selection unit 220 may select user C in response to user C's availability complementing user A's availability even though user E has a higher skill level than user C, because user E's availability does not complement the availability of user A (who is ipso facto a member of the group due to being the first user).

The selection unit 220 may then select the user that is a tank since the requirements for a DPS and a healer have been filled by user A and user C. In this example, the selection unit 220 may select user B in response to user B having a language in common (FR) with the users already selected for the group of users (A and C) even though user D has a higher skill level than user B, because user D only shares a language with user A but not user C. Therefore, if user D was selected instead of user B, user C and user D may not be able to communicate effectively.

However, it should be noted that, in some cases such as a case where user B has a skill level of 100, user D may be selected instead of user B even though user D does not share a language with one of the users that has already been selected for the group because the impact of two of the users not being able to communicate may be assessed by the selection unit 220 to be lower than the impact caused by such a large skill difference between players B and D.

Alternatively, or in addition, in some embodiments of the present disclosure, a respective one of the other users may be selected in further dependence upon whether the respective other user has already received a potential reward for completing the given task.

As an illustrative example, the potential reward for a given task may, for example, include one or more particular in-game items such as weapons or armour. In some cases, there may only be one of each type of item allocated to a group for a successful completion of a given task. The first user, who is looking to complete the given task, may desire a certain one of the in-game items given as a potential reward for the given task. Therefore, in this case, it may advantageous to preferentially select a respective one of the other users over another respective other user (all else being equal) if the respective other user has already obtained the certain one of the in-game items desired by the first user because the respective other user won't be competing with the first user for the certain one of the in-game items.

Additionally, a respective other user may desire a different one of the in-game items given as a potential reward for the given task. The respective other user may be preferentially selected over another respective other user (all else being equal) if the first user has already received the different one of the in-game items.

To summarise this illustrative example, a respective other user may be preferentially selected over another respective other user if, all else being equal, the respective other user will not be competing with the first user for one or more of the potential rewards for the given task.

It should be noted that, in some cases, a respective other user may be preferentially selected over another respective other user if, all else being equal, the respective other user has not received a potential reward for the given task. For example, a potential reward for a given task may include a particular trophy/achievement. In this case, it may be advantageous to preferentially select a respective other user over another respective other user (all else being equal) when the respective other user does not have a particular trophy/achievement because the respective other user will be more motivated to fulfil the conditions for obtaining the particular trophy/achievement (e.g. complete the given task within half the allocated time) whilst participating in the given task in comparison to the other respective other user who would have nothing to gain by fulfilling the conditions for obtaining the particular trophy/achievement again.

The group generation unit 230 is configured to generate the group for the first user to complete the given task, the generated group comprising the first user and the one or more selected other users.

For example, the group generation unit 230 may be configured to generate the group by transmitting an invitation to join the group to the selected other users. In this case, a respective one of the selected other users may be added to the group in response to accepting the invitation.

Alternatively, the group generation unit 230 may be configured to generate the group by adding the selected other users to the group in response to a respective one of the selected other users being selected by the selection unit 220.

In some cases, both of the above techniques may be used. For example, whether the group generation unit 230 is configured, for a respective other user, to automatically add the respective other user to a group or to transmit an invitation to join the group to the respective other user, may depend on a user preference indicated by the respective other user. Therefore, some of the selected other users may be automatically added to the group whilst other ones of the selected other users may receive an invitation to join the group.

In a case where at least one of the selected other users receives an invitation to join a group and declines the invitation, the generated group comprises the first user and the selected other users that were automatically added to the group by the group generation unit 230 and the selected other users that accepted an invitation to join the group.

Again, the group generation unit may be based on a server, on the first user's console, or on a mixture of the two, with requests and responses as appropriate. For example the console may transmit the IDs of selected other users (and typically the first user) to a server that administers the multiplayer aspect of the game. Alternatively, the console may send invites and collate the members of the group, and either administer the game itself or notify an administrating server.

More generally it will be appreciated that one or more of the identification unit, selection unit, group generation unit (or scheduling unit, described later herein) may reside on a console, a server, or have their role shared between both. It will also be appreciated that for a cloud hosted or cloud streaming service, one or more of the participating user consoles may be part of such a server or servers. Hence also reference to a processing device for generating a group of users may optionally encompass a processing system spanning two or more discrete devices (consoles and/or servers, real and/or virtual).

In these cases, this may be the final composition of the generated group. However, in some cases, the selection unit 220 may be configured to select a further number of other users from the plurality of users in accordance with the techniques that have been described elsewhere herein. In this case, the further number may correspond to the number of selected other users that declined an invitation to join the group.

Optionally, in some cases, a selected other user failing to respond to an invitation to join a group within a predetermined period of time (which may be set by a developer or by the first user for example) may be considered, by the group generation unit 230, as the invitation being declined by the selected other user.

In some embodiments of the present disclosure, the identification unit 210 may be further configured to identify the given task for the user in dependence upon the first user's past interaction with the video game and/or the first user's progression in the video game. In these embodiments, a respective one of the other users may be selected in further dependence upon having previously been identified for the given task.

For example, the first user may be repeatedly attempting a particular in-game mission or quest. In some cases, the first user may be failing to complete the in-game mission or quest. In dependence upon the first user failing to complete the particular in-game mission or quest that they are repeatedly attempting, the identification unit 210 may identify the particular in-game mission or quest as a given task for generating a group for the first user to assist the first user in completing the given task.

Additionally, a respective one of the other users may have had the particular in-game mission or quest identified as a given task in a manner similar to how the first user may have had the particular in-game mission or quest identified as the given task described above. In this case, the respective other user may be selected in further dependence upon having previously been identified for the same given task as the first user. Therefore, the respective other user and the first user may assist one another in completing the given task. It should be noted that, in these embodiments, the selection unit 220 is not limited to only selecting other users that have previously been identified for the given task but may also select one or more other users that have not previously been identified for the given task.

As another example, the first user may be repeatedly, and successfully, completing a particular in-game mission or quest (or may be staying in a particular region of a virtual environment). In some cases, when a user exhibits this type of behaviour, they may be attempting to obtain a particular trophy/achievement for completing the particular in-game mission or quest whilst fulfilling one or more additional conditions (such as completing the in-game mission or quest without taking damage, within a predetermined amount of time, without being detected, etc.).

In this case, the identification unit 210 may be configured to identify obtaining the particular trophy/achievement as the given task for the first user in dependence upon the first user repeatedly, and successfully, completing a particular in-game mission or quest. In this case, a respective one of the other users may be selected in further dependence upon having previously been identified for the given task of obtaining the particular trophy/achievement. Therefore, the group generated by the group generation unit 230 may advantageously be formed of users dedicated to completing the given task.

In some cases, as previously noted, at least one of the requirements may be a requirement specifying one or more in-game characteristics that are preferable, but not essential, for at least one of other users to have for assisting the user in completing the given task. For example, it may be preferable for at least one of the other users to have a skill level at or above a particular skill level.

In these cases, the selection unit 220 may be configured to select one or more other users from the plurality of other users, where respective one of the other users is associated with the one or more preferable in game characteristics. However, in some cases, the group generation unit 230 may not be able to generate a group for the given task from the selected other users. For example, one or more of the selected other users may decline an invitation to join the group, or there may not be one or more other users associated with the one or more preferable in game characteristics for the selection unit 220 to select (i.e. none, or not enough, of the other users possess the one or more preferable in-game characteristics). Therefore, it may not be possible to generate a group that fulfils the one or more preferable requirements.

Therefore, in some embodiments of the present disclosure, the identification unit 210 may be configured to modify at least one of the requirements in response to a predetermined period of time passing, from a request to generate a group for the given task, without a group being generated by the group generation unit 230.

Therefore, if, for example, the group generation unit 230 has been unable to generate a group within the predetermined period of time (because, for example, there may currently not be any/enough other users that meet the one or more requirements or the other users that meet the one or more requirements have declined an invitation to join the group), the identification unit 210 may modify at least one of the requirements. For example, the identification unit 210 may modify a requirement for at least one of the other users to have a skill level at or above a particular skill level by lowering the particular skill level for at least one of the other users to have and/or modify a requirement for at least one of the users to have a particular class/build (e.g. DPS) by allowing a hybrid class/build (e.g. a DPS/tank hybrid) or one or more other types of class/build (e.g. tank or healer) to fulfil the requirement.

Optionally, in these embodiments of the present disclosure, the identification unit 210 may be configured to assign a priority value to a respective one of the one or more requirements when identifying the one or more requirements. In these embodiments, the identification unit 210 may be configured to choose which of the requirements to modify in dependence upon the assigned priority values.

Therefore, the requirements chosen to be modified by the identification unit 210 may, for example, be the requirements that, after being modified, will have the lowest impact on the ability of the group to complete the given task in comparison to if one or more of the other requirements were modified by the identification unit 210.

In some cases, once a group has been generated by the group generation unit 230, the group is not required to attempt the given task immediately. Additionally, it should be noted that the users selected by the selection unit 220 or that are part of the group generated by the group generation unit 230 are not necessarily required to be online at the time when they are selected by the selection unit 220 or added to the group by the group generation unit 230. In these cases, the group may be generated for attempting the given task at some point in the future.

Therefore, in some embodiments of the present disclosure, the processing device 200 may optionally (as indicated by the dashed outline in FIG. 2) comprise a scheduling unit 240 that may be configured to schedule a start time for the given task in dependence upon an availability of the first user and the one or more selected other users.

For example, as discussed elsewhere herein, one of the in-game characteristics may be indicative of when a user is likely to be available/unavailable (which may be estimated based on previous patterns of availability or may be information supplied by the user for example). Therefore, the scheduling unit 240 may be configured to schedule a start time for the given task at a point in time when the first user and the selected users are mutually available, and optionally when there is at least a predetermined continuous period of time of mutual availability from that point in time (the predetermined continuous period of time may, for example, be dependent upon how long it took one or more other groups to complete the given task the given task).

It should be noted that a given task may be started and progressed even if all the members of the group are not online or even participating in the given task at the same time. For example, the given task may be a turn-base task in which each participating user does not need to participate simultaneously with the other participating users.

Referring now to FIG. 3, in some embodiments of the present disclosure, a method 300 for generating a group of users for a first user to complete a given task in a video game, completion requiring one or more in-game characteristics, is provided according to embodiments of the present disclosure. The method 300 comprises the steps of identifying 310 one or more requirements of the given task; selecting 320 one or more other users from a plurality of other users, wherein a respective one of the other users is selected in dependence upon at least one of the requirements and one or more in-game characteristics associated with the respective other user; and generating 330 the group for the first user to complete the given task, the generated group comprising the first user and the one or more selected other users.

Optionally, in some embodiments of the present disclosure, the method 300 comprises a step of scheduling a start time for the given task in dependence upon an availability of the first user and the one or more selected other users.

In some embodiments of the present disclosure, a computer program is provided. The computer program comprising computer executable instructions adapted to cause a computer system to perform any of the methods for generating a group of users for a first user to complete a given task in a video game described elsewhere herein.

It will be appreciated that the above methods may be carried out on conventional hardware (such as the processing device 200, entertainment device 10, or HMD 802) suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A processing device for generating a group of users for a first user to complete a given task in a video game, completion requiring one or more in-game characteristics, the processing device comprising:
an identification unit configured to identify one or more requirements of the given task;
a selection unit configured to select one or more other users from a plurality of other users, wherein a respective one of the other users is selected in dependence upon at least one of the requirements and one or more in-game characteristics associated with the respective other user; and
a group generation unit configured to generate the group for the first user to complete the given task, the generated group comprising the first user and the one or more selected other users.

2. The processing device according to claim 1, in which a respective one of the other users is selected in response to at least one of their associated in-game characteristics complementing users already in or selected for the group of users.

3. The processing device according to claim 1, wherein a respective one of the other users is selected in further dependence upon one or more user characteristics associated with the first user.

4. The processing device according to claim 1, wherein the one or more requirements comprise one or more user specific requirements that correspond to the one or more in-game characteristics of a respective other user.

5. The processing device according to claim 4, the identification unit is configured to identify the one or more user specific requirements for the given task in dependence upon one or more in-game characteristics of respective users in one or more other groups that have completed the given task.

6. The processing device according to claim 1, wherein the one or more requirements comprise one or more group requirements that correspond to the combined complement of in-game characteristics associated with members of a group for the given task.

7. The processing device according to claim 6, the identification unit is configured to identify the one or more group requirements in dependence upon the combined complement of in-game characteristics associated with members of one or more other groups that have completed the given task.

8. The processing device according to claim 1, wherein a respective one of the other users is selected in further dependence upon whether the respective other user has already received a potential reward for completing the given task.

9. The processing device according to any claim 1, wherein the identification unit is further configured to identify the given task for the user in dependence upon the first user's past interaction with the video game and/or the first user's progression in the video game, wherein a respective one of the other users is selected in further dependence upon having previously been identified for the given task.

10. The processing device according to any claim 1, wherein the identification unit is configured to modify at least one of the requirements in response to a predetermined period of time passing, from a request to generate a group for the given task, without a group being generated by the group generation unit.

11. The processing device according to claim 10, wherein the identification unit is configured to assign a priority value to a respective one of the one or more requirements when identifying the one or more requirements, and is configured to choose which of the requirements to modify in dependence upon the assigned priority values.

12. The processing device according to any claim 1, further comprising a scheduling unit configured to schedule a start time for the given task in dependence upon an availability of the first user and the one or more selected other users.

13. A method for generating a group of users for a first user to complete a given task in a video game, completion requiring one or more in-game characteristics, the method comprising the steps of:
identifying one or more requirements of the given task;
selecting one or more other users from a plurality of other users, wherein a respective one of the other users is selected in dependence upon at least one of the requirements and one or more in-game characteristics associated with the respective other user; and
generating the group for the first user to complete the given task, the generated group comprising the first user and the one or more selected other users.

14. The method according to claim 13, in which a respective one of the other users is selected in response to at least one of their associated in-game characteristics complementing users already in or selected for the group of users.

15. A non-transitory, computer readable storage medium containing a computer program comprising computer executable instructions that when executed by a computer system, cause the computer system to perform a method for generating a group of users for a first user to complete a given task in a video game, completion requiring one or more in-game characteristics, the method comprising the steps of:
identifying one or more requirements of the given task;
selecting one or more other users from a plurality of other users, wherein a respective one of the other users is selected in dependence upon at least one of the requirements and one or more in-game characteristics associated with the respective other user; and
generating the group for the first user to complete the given task, the generated group comprising the first user and the one or more selected other users.
